(19) United States
(12) Patent Application Publication
(10) Pub. No.: US 2015/0294367 A1
(43) Pub. Date: Oct. 15, 2015

(54) LOCATION AND/OR SOCIAL MEDIA-BASED EFFECTS AND AD PLACEMENT FOR USER-GENERATED MEDIA

(71) Applicant: Vivoom, Inc., Cambridge, MA (US)

(72) Inventors: Gary C. Oberbrunner, Somerville, MA (US); Katherine Hays, Boston, MA (US)

(21) Appl. No.: 14/574,157

(22) Filed: Dec. 17, 2014

Related U.S. Application Data
(60) Provisional application No. 61/979,320, filed on Apr. 14, 2014.

(51) Int. Cl. G06Q 30/02; G06Q 50/00

(52) U.S. Cl. CPC G06Q 30/0269; G06Q 30/0261; G06Q 30/0252; G06Q 50/01

(57) ABSTRACT

The disclosed technology employs systems and methods that use, for example, location data, time data, social media actions, or social preferences to deliver (e.g., in real time) targeted advertising content or media. This advertising content or media can be merged with user-generated media, forming a unified media object having greater value to users, advertisers, and content partners. These unified media objects can then be shared to the benefit of all parties. Furthermore, the disclosed technology may also use location, time, and/or social data to deliver (e.g., in real time) targeted visual or audio effects (or treatments) that can modify and enhance such user-generated media, prior to sharing it. This platform has the benefit that the effects applied are more relevant and engaging to both the user and the viewers of the user's content.

### RELATED APPLICATIONS

This application is a U.S. non-provisional application that claims the benefit of U.S. Provisional Application No. 61/979,320, titled LOCATION-BASED EFFECTS AND AD PLACEMENT FOR USER-GENERATED MEDIA, filed on Apr. 14, 2014 which is related to U.S. Provisional Patent Application No. 62/074,879 titled LOCATION AND/OR SOCIAL MEDIA-BASED EFFECTS AND AD PLACEMENT FOR USER-GENERATED MEDIA filed on Nov. 4, 2014, U.S. Provisional Patent Application No. 61/171,657, titled SHARING OF PRESETS FOR VISUAL EFFECTS, filed on Apr. 22, 2009, U.S. patent application Ser. No. 12/765,541, titled SHARING OF PRESETS FOR VISUAL EFFECTS OR OTHER COMPUTER-IMPLEMENTED EFFECTS, filed on Apr. 22, 2010, now U.S. Pat. No. 8,412,729, U.S. patent application Ser. No. 13/854,299, titled SHARING OF PRESETS FOR VISUAL EFFECTS OR OTHER COMPUTER-IMPLEMENTED EFFECTS, filed on Apr. 1, 2013, now U.S. Pat. No. 8,667,016, U.S. Provisional Patent Application No. 61/545,330, titled METHOD FOR NETWORK-BASED RENDERING AND STEERING OF VISUAL EFFECTS, filed on Oct. 10, 2011, International Application No. PCT/US2012/059572, titled NETWORK-BASED RENDERING AND STEERING OF VISUAL EFFECTS, filed on Oct. 10, 2012, U.S. patent application Ser. No. 14/349,178, titled NETWORK-BASED RENDERING AND STEERING OF VISUAL EFFECTS, filed on Apr. 2, 2014, each of which is incorporated herein by reference in its entirety.

### BACKGROUND

People want to be able to share their passions with friends and family. They would like to share their own user-generated content or media in ways that are compelling and interesting. There are many services today that allow users to record video or photo content and upload it to an Internet server for sharing with a group of friends or family, as well as publicly. Simultaneously, advertisers and sponsors would like new ways to reach viewers; ways that are unobtrusive and yet build interest in and awareness of their brand.

### BRIEF DESCRIPTION OF THE DRAWINGS

FIG. 1 is a block diagram illustrating various aspects of the disclosed system in some examples.

FIG. 2 is a block diagram illustrating processing of a location-based enhance component of a client system in accordance with some examples of the disclosed technology.

FIG. 3 is a block diagram illustrating processing of a social action-based enhance component of a server system in accordance with some examples of the disclosed technology.

FIGS. 4A and 4B are display pages illustrating user-generated media and enhanced user-generated media in the form of a unified media object in accordance with some examples of the disclosed technology.

FIG. 5 is a block diagram illustrating some of the components that may be incorporated in at least some of the computer systems and other devices on which the facility operates and with which the facility interacts.

### DETAILED DESCRIPTION

The disclosed technology employs systems and methods that use, for example, location data, time data, social media actions (e.g., posting, liking, following, commenting) or social preferences (e.g., bands, teams, or people that a user follows on a social networking site or that the user has expressed an interest in) to deliver (e.g., in real time) targeted advertising content or media (e.g., logos, flying logos, flying banners, lower thirds, branded frames, voiceovers, sound overlays, pre- or post-rolls, composited items) that is then merged with user-generated media, forming a unified media object having greater value to users, advertisers, and content partners, such as a band, sports organization, performer, etc. These unified media objects can then be shared to benefit all parties. Furthermore, the disclosed technology may also use location, time, and/or social data to deliver (e.g., in real time) targeted visual or audio effects (or treatments) to be used to modify and enhance such user-generated media prior to sharing it. This platform has the benefit that the effects applied are more relevant and engaging to both the user and the viewers of the user's content, prompting the user to continue using the service and prompting viewers to view the content, view the content for longer, and give the user positive social feedback (e.g., “likes” or comments on the user's content). This in turn may drive additional advertising or other revenue, by increasing the number of users and/or increasing the number of views and re-shares of the resulting content.

In some examples, content is merged with ad media using “client side processing.” In these examples, the client receives the ad media and merges the ad media with the user-generated media. For example, the ad media may take the form of a semi-transparent logo, frame, or identifying mark that the client can composite onto the user-generated media, using e.g. any standard compositing operator, such as OVER, PLUS, or SCREEN. The client can then send the final composited media to the server or directly to a sharing service.

In some examples, content is merged with ad media using “server side processing.” In these examples, the client transmits the user-generated media and location and/or social data to the server. The server composites, prepends, appends, and/or otherwise integrates the ad media onto the user-generated media, using, e.g., any standard compositing operator, and sends the final composited media to a sharing destination.

In the case of video, the ad media is typically also video but may also contain audio. The video tracks are merged by compositing, and the audio tracks are merged by mixing, appending, prepending and/or replacing the audio tracks. In the case of audio only, the tracks are merged by mixing them together. In the case of photo media, the ad media may also be a still image, with optional transparency; the ad is overlaid over the user's photo.

### Effects

In some examples, the ad media may not be simply a fixed set of frames with an optional compositing method; it may also contain one or more video or audio effects to be applied to the user-generated media and/or the ad media in order to integrate them into the final shareable product. For example, the ad media may be a partially transparent logo, and the effect may be computer instructions to blur and/or enhance the colors of the user-generated media and/or move the logo across a screen for artistic effect, while compositing the logo over the user-generated media. For another example, the ad media may be a logo, and the effect may instruct the system to simulate embossing the logo onto the user-generated media. In some cases, the effect may itself be the ad media; no other frames or content may be needed. For example, the effect may be an effect to make a user's video look like a popular music video. In some examples, the effects are resolution-independent, multithreaded, fully anti-aliased, resistant to popping, resistant to jitter, without errant edge effects, and/or contain fully floating point internals.

Ad media and effects can be delivered or targeted to a user based on a combination of the client's geographical location (latitude and longitude), current time and date, local scheduling information, weather, demographics, social media preferences or status, social media actions, and/or other information about the user, if any, and so on, based on a campaign configuration or profile specified by the advertiser or effects sponsor. For example, a user who is in a particular stadium during a particular soccer game could be delivered ad content or effects relevant to the teams playing in the game, an upcoming game, or a particular advertiser or event sponsor, such as an advertisement for the home team's sponsor or an effect to replace colors in an image or video with the home team's colors. As another example, a user who is in a concert venue during or soon after a particular concert could be delivered ad content or effects relevant to the artist, the venue, or similar artists, such as an advertisement for the artist's new album or an effect used in a recent music video by the artist. As another example, a 21-year old male at a festival may be delivered different ad media or effects than a 35-year-old female at the same location and time. As another example, a user who enters or approaches a popular coffee chain may be offered content or effects based on his/her social media preferences as well as the location. In some examples, a user may be notified that she has received or unlocked one or more packages containing effects and/or pieces of advertising media when the user enters a particular venue or performs a particular social activity or action, such as liking or commenting on a content sponsor's media post.

In some examples, the disclosed system employs a client device (which may be a mobile phone, tablet, desktop computer, wearable device, etc.) and a server connected via a network (e.g. cell network or Internet). Software on the client device enables recording, storage, modification, uploading, and sharing of media. The server can mediate between the client device and the user's desired sharing services, such as Facebook, Twitter, Tumblr, Google+, or others. The server software delivers ad media to the client, and in some embodiments performs the integration of ad media, effects, and user-generated media. A user uses the client device to record media content (e.g., recording a video, taking a photo, recording audio). The recording may be done via the client software or other third party software. The client software then enables the modification, ad integration, and sharing of the content via, for example, a social networking site.

In some examples, prior to sharing the content in a social network, website or other Internet property, the user's location is determined (e.g., using GPS, cell phone tower proximity, proximity sensing systems such as iBeacons, or proximity to Wi-Fi access points) and transmitted to the server. The client and server may determine, location, based on the user's account information (if any), as well as time, date, social data retrieved from the user's social networks or other sources, a set of relevant location-based advertising content and/or effects to be integrated with the user's media, and other factors. For each of these relevant pieces of advertising content and/or effects (i.e., results), the server software delivers a description and zero or more thumbnail samples of the results to the client. The server may then apply selected results (e.g., composite a selected piece of advertising content or effect with user-generated media), or query the user to determine which of several applicable results to apply. In some examples, the server may deliver a description and one or more thumbnail samples of the desired pieces of advertising content and/or effects to the client and the user can select which to apply. After the media is integrated, the integrated media is transmitted to the sharing destination, e.g. Facebook, Twitter, Tumblr, Google+, or others, or shared privately, such as with a friend via email or SMS or MMS message. In all cases sharing can be done either directly from the client, or via the server, or via downloading and storing the media. In an alternative embodiment, the server may transmit to the client instructions for applying the relevant effects and/or integrating the relevant pieces of advertising content. The client then processes the effects on the video locally. The client can then share the resulting media directly to a sharing destination or download and store the media.

Receiving geographic coordinates via Wi-Fi or GPS is much more precise than those from cell phone tower geo proximity systems. Coordinates obtained from cell towers make use of signal strength and triangulation, both of which can be limited in, for example, rural and urban locations. In some examples, these drawbacks can make obtaining precise geographic coordinates impossible, inaccurate, or simply take an unacceptable amount of time. For this reason, the disclosed system detects whether a client is obtaining geographic coordinates via a cell tower instead of Wi-Fi or GPS, the geo fencing border is extended based on that deficiency and may be scaled by precision to a limit of, for example, 200 meters.

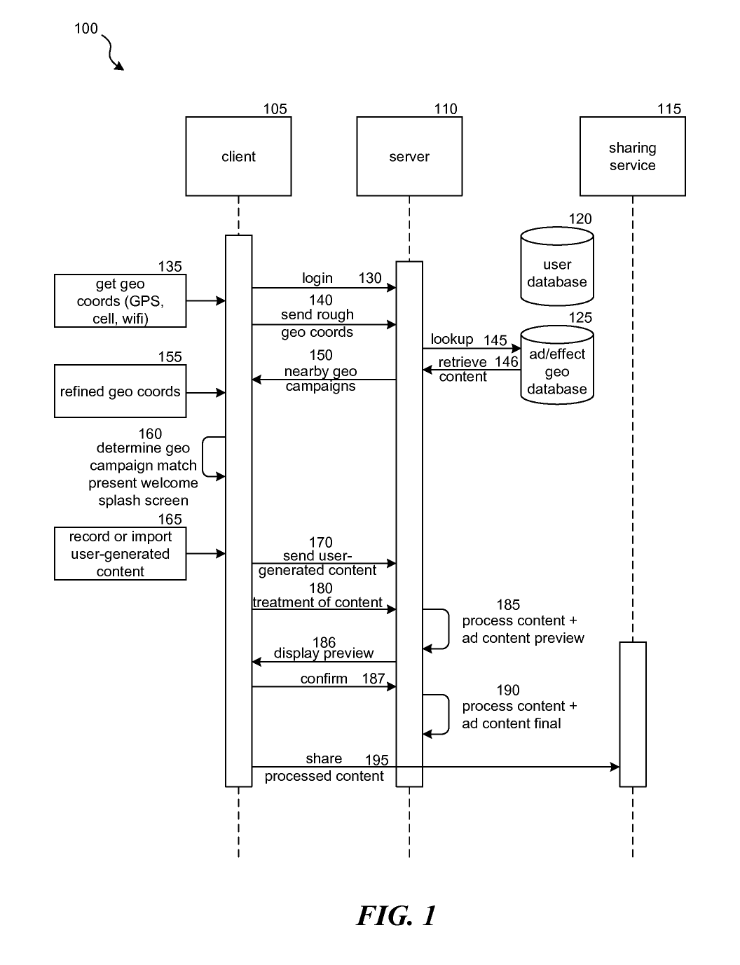

FIG. 1 is a block diagram illustrating various aspects of the disclosed system in some examples. In this example, the system 100 includes a client 105, a server 110, a sharing service 115, a user database 120, and a campaign database 125. The campaign database stores advertising and effects/treatment information for each of one or more campaigns, such as an advertising campaign, an effects campaign, and so on. Furthermore, each campaign may be associated with additional targeting information, such as user demographic information, time restraints or conditions, social media/networking actions, geo-fenced locations, and so on. At step 130, the client logs into the server using, for example, a user name and password previously established with the server. Each user's account information can be stored in user database 120, along with user profile information, such as the user's name, preferences, interests, affinities, history, and so on. If the user has not established an account, the server may prompt the user to do so. At step 135, the client retrieves location information for the client, such as geographic coordinates. In some examples, the location information may be coarse or roughly estimated based on available information, such as signal strength, estimated distances from signal towers, and so on. As another example, the client may use geo-fencing information to determine whether the client is within a geo-fenced area. At step 140, the client sends the location information to the server. At step 145, the server looks up and selects advertising content and/or effects information based on, for example, the location information and the day/time. For example, the advertising/effects database may map location and day/time information to advertisements and/or effects. In this manner, an effect to accentuate the lighting of the Eiffel Tower at night may be selected for users generating content near the Eiffel Tower at night. Similarly, a sepia effect may be selected for users generating content near an old “wild wild west” town or a ghost town. Furthermore, an entity (such as a sports team or an artist (or their representatives)) can target advertisements and/or effects to users who are present at a particular location or venue during a certain time. As an example, a football team and/or one of its sponsors, may establish and register certain pieces of advertisements or effects to be provided to users generating content during a football game if those users are at or near the football game. In some cases, different pieces of advertising content or effects may be made eligible based on the current score of the game, an in-game achievement performed by a player (e.g., touchdown or interception), and so on. As another example, fans of a particular artist may be eligible to incorporate unique advertising content or effects into user-generated media if they are present at one of the artist's concerts. The system may also include advertising content or effects that are unique to a particular song performed by the artist during the concert. In this manner, the user can publicize or announce to their followers and others that they are at a particular event using advertisements or effects unique to that event, which may encourage users to attend the event and increase ticket sales. Furthermore, the entities are encouraged to produce advertising content and effects unique to certain events or shows so that users can obtain and include these elements in their user-generated media. At step 146, the server retrieves the advertising content and/or effects. At step 150 the server identifies campaigns that are associated with locations near the location of the client and provides an indication of those nearby campaigns to the client. For example, the server may identify all of the campaigns associated with locations within a threshold distance from the client, such as 100 feet, 1 mile, 50 kilometers, and so on. In some examples, the server may provide the client with one or more content keys to access the campaign(s). At step 155 the client gets precise geographic coordinates by, for example, obtaining GPS coordinates. At step 160 the client unlocks the campaign or campaigns that match all criteria and presents welcome information in the client. At step 165, the client records or imports user-generated media, such as video, image(s), and/or audio clip(s). At step 170, the client sends the user-generated media, such as an image, video, or audio recording, to the server. At step 180, the treatment associated with the campaign is applied automatically or as selected by the user. For example, if the campaign is associated with a single video treatment, then the video treatment is applied to the user-generated media. As another example, if the campaign is associated with multiple video, still image, and audio treatments then one or more of the treatments can be selected by the user and applied to the user-generated media. Furthermore, a treatment may have various options or settings relating to configuration information, such as placement, size, alpha value for transparency, color, effect strength and/or position, etc. that the user can configure before the treatment is applied to the user-generated media. At step 185, the server composites the user-generated and advertising content and/or effects information into a unified media object (e.g., one or more images and video files) for preview purposes. At step 186, the server generates and sends a preview of the unified media object and sends the preview to the client for review. If the client confirms the preview at step 187, then the server shares the unified media object to the sharing service, else the server returns to step 150 to look up additional advertising content and/or effects. At step 190 the server composites the user-generated and advertising content and/or effects information into a unified media object (e.g., one or more images and video files) for final high quality consumption. At step 195 the client chooses to share the video object with or without sharing text to one of many sharing services. Although in the example above the system composites user-generated and advertising content based at least in part on location information, one of ordinary skill in the art will recognize that the system can composite user-generated and advertising contest based other information, such as time data, social media actions, social preferences, and so on and combinations thereof (e.g., location information and time data). For example, a user may unlock an enhancement or treatment to be combined with content by performing a particular social media action, such as liking an image or following a social media page or account of an artist during a particular time frame. As another example, a user may unlock an advertisement to be combined with other content by following a band's social media account while at a performance by the band.

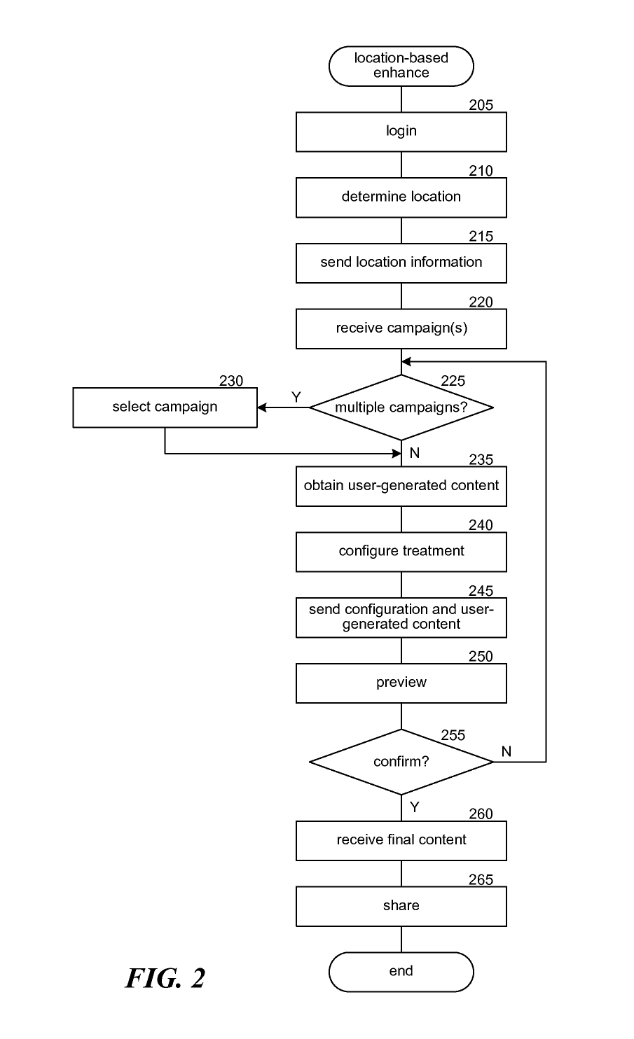

FIG. 2 is a block diagram illustrating the processing of a location-based enhance component of a client system in accordance with some examples of the disclosed technology. The component is invoked by a client system to have user-generated media enhanced and shared based on location information. In block 205, the component logs a user of the client device into a server system by, for example, prompting the user to provide credentials (e.g., username and/or password) and sending the credentials to the server system. In block 210, the component determines location information for the client device. The location information may be determined in any number of ways, such as GPS, cell phone tower proximity, proximity sensing systems, proximity to Wi-Fi access points, and so on. In block 215, the component sends the determined location information to the server system. The server system uses the location information to identify campaigns that have location criteria satisfied by the determined location information. For example, a campaign may specify a center point and a radius to define an area associated with the campaign. As another example, a campaign may specify points or vertices of one or more polygons that defines an area or areas associated with the campaign. In some examples, the area may be specified more generally, such as an area corresponding to a ZIP code, municipality, county, state, province, country, and so on. One of ordinary skill in the art will recognize that the area can be determined in any number of ways. In block 220, the component receives the qualifying campaign(s) (e.g., the campaigns associated with location criteria satisfied by the determined location information) from the server system. In decision block 225, if multiple campaigns qualify, then the component continues at block 230, else the component continues at block 235. In block 230, the component prompts the user to select one or more of the qualifying campaigns. In block 235, the component obtains user-generated media by, for example, capturing content with a camera or microphone or retrieving content from a data store. In block 240, the component configures the treatments or enhancements associated with the selected campaigns according to settings received from the user. In block 245, the component sends the configuration information settings and selected user-generated media to the server system, which applies the treatments or enhancements to the user-generated media in accordance with the configuration information. In block 250, the component receives a preview of the treated user-generated media from the server system and presents the preview to the user, such as a low quality or low resolution version of the treated user-generated media. In decision block 255, if the user confirms the preview then the component sends an indication of the confirmation to the server system and continues at block 260, else the component loops back to decision block 225 to determine whether there are multiple qualifying campaigns. In block 260, the component receives, from the server system, finalized content, such as a high quality or high resolution version of the treated user-generated media or a URL link to the finalized content. In block 265, the component shares the final content by, for example, sending the finalized content or a URL link to the finalized content to a group of users, posting the final content to a social networking site, and so on. Although the component above is described as enhancing user-generated media based on location information, one of ordinary skill in the art will recognize that campaigns can be selected for a user or device based on information other than, or in addition to, location information, such as time data, social media/network actions, social preferences, and so on.

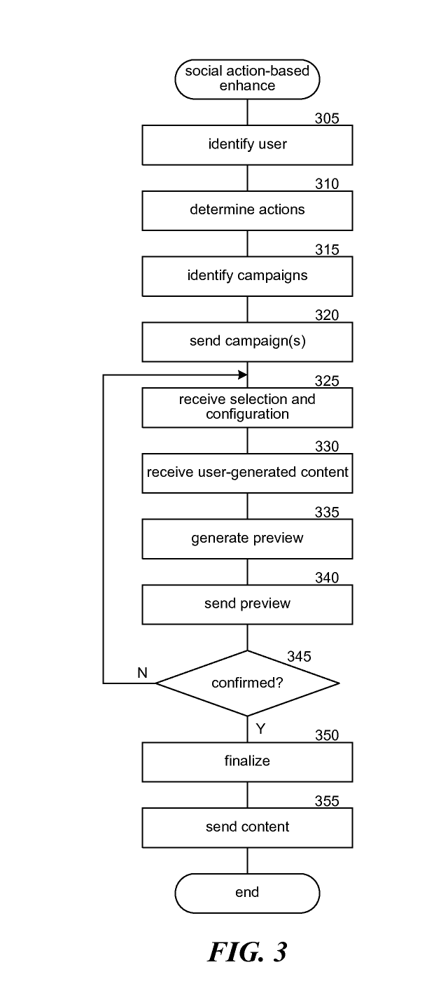

FIG. 3 is a block diagram illustrating the processing of a social action-based enhance component of a server system in accordance with some examples of the disclosed technology. The component is invoked by a server system to have user-generated media enhanced and shared based on social action information. In block 305, the component identifies a user based on, for example, a username and/or password received from a client device. In block 310, the component determines actions associated with the identified user. For example, the component may retrieve the actions from a data store maintained by the server system. As another example, the component may access one or more social networking sites accessed by the user to determine social actions performed by the user on those social networking sites. In some examples, the component may receive the actions from a client device that is associated with the user and that maintains a log of actions performed by the user. In block 315, the component identifies campaigns associated with criteria that are satisfied by the determined actions. For example, a campaign may be associated with criteria specifying that a user needs to “follow” a particular account or accounts, such as the accounts of a particular artist or band, or criteria specifying that a user must have posted a message containing a particular hash tag during the last hour. As another example, a campaign may be associated with criteria specifying that a user must have tagged a particular user or account in a post (e.g., identifying the particular user or account in the post). In block 320, the component sends an indication of the identified campaigns to the client device. In block 325, the component receives a selection of one or more campaigns and settings for associated configuration information. In block 330, the component receives user-generated media, such as an image, video, or audio. In block 335, the component generates a preview based on the user-generated media and the selected campaign(s) by applying the treatments/enhancements associated with the selected campaigns to the user-generated media in accordance with the received settings. In block 340, the component sends the preview to the client device. In decision block 345, if the component receives a confirmation from the client device then the component continues at block 350, else the component loops back to block 325 to receive a selection of one or more campaigns and associated configuration information. In block 350, the component finalizes the content. In block 355, the component sends the finalized content, or a URL link to the finalized content, to the client device. Although the component above is described as enhancing user-generated media based on social actions, one of ordinary skill in the art will recognize that campaigns can be selected for a user or device based on information other than, or in addition to, social actions, such as location information, time data, social preferences, and so on.

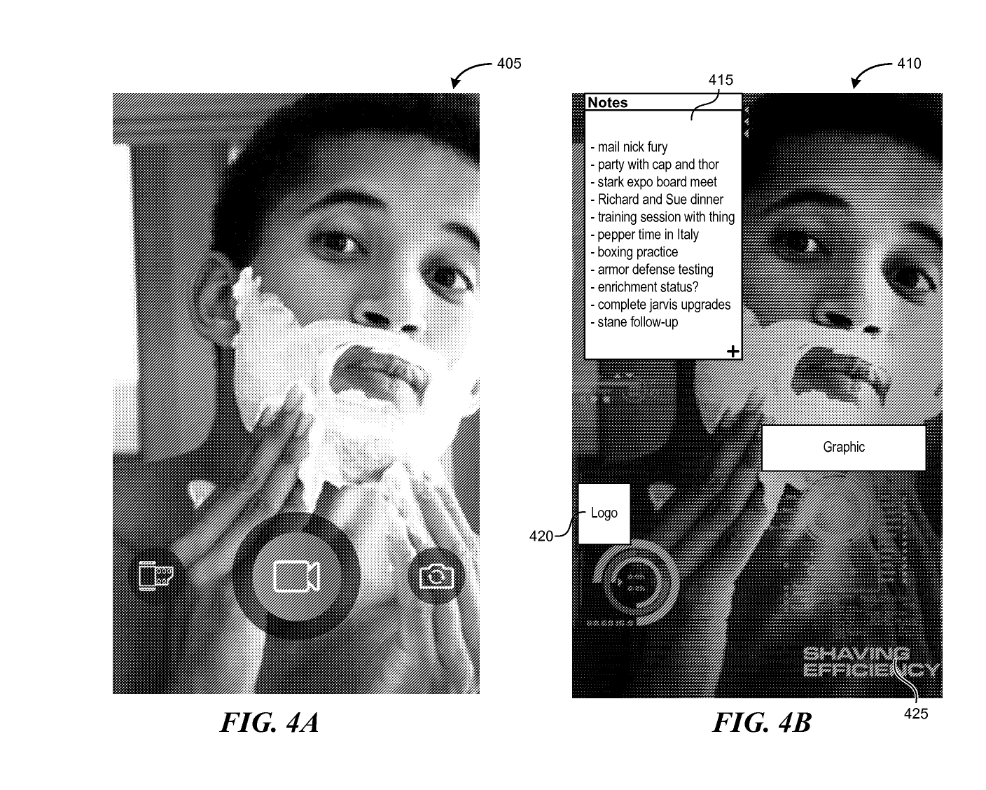

FIGS. 4a and 4b are display pages illustrating user-generated media and enhanced user-generated media in the form of a unified media object in accordance with some examples of the disclosed technology. FIG. 4a is a display page showing an image 405 of a user preparing to shave. In this example, the captured image corresponds to user-generated content captured by, for example, a mobile phone. In FIG. 4b, the user-generated content has been enhanced to include several additional features, including notes 415, logo 420, and a graphic overlay 425 combined into a united media object 410. In this example, graphic overlay 425 is included as a result of the user's association with a particular shaving company and represents a mock “shaving efficiency” graphic to highlight the shaving company's brand. In this example, the graphics overlay includes a series of horizontal lines and other graphics to alter the look and feel of the original user-generated media 405. In this example, unified media object 410 also includes company logo 420, which is included as a result of the user's association with logo 420′s company during a recent promotion. Furthermore, notes 415 section represents a list of the user's upcoming events drawn from, for example, the user's online calendar. One of ordinary skill in the art will recognize that user-generated media can be modified or enhanced in any number of ways based on, for example, location data, time data, social actions, and so on in accordance with the disclosed technology.

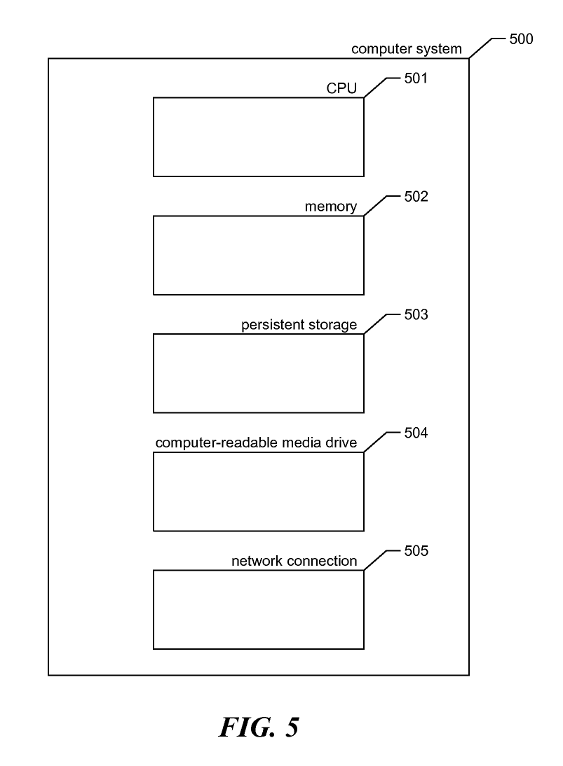

FIG. 5 is a block diagram illustrating some of the components that may be incorporated in at least some of the computer systems and other devices on which the system operates and with which the system interacts in some examples. In various examples, these computer systems and other devices 500 can include server computer systems, desktop computer systems, laptop computer systems, netbooks, tablets, mobile phones, personal digital assistants, televisions, cameras, automobile computers, electronic media players, and/or the like. In various examples, the computer systems and devices include one or more of each of the following: a central processing unit (“CPU”) 501 configured to execute computer programs; a computer memory 502 configured to store programs and data while they are being used, including a multithreaded program being tested, a debugger, the facility, an operating system including a kernel, and device drivers; a persistent storage device 503, such as a hard drive or flash drive configured to persistently store programs and data; a computer-readable storage media drive 504, such as a floppy, flash, CD-ROM, or DVD drive, configured to read programs and data stored on a computer-readable storage medium, such as a floppy disk, flash memory device, a CD-ROM, a DVD; and a network connection 505 configured to connect the computer system to other computer systems to send and/or receive data, such as via the Internet, a local area network, a wide area network, a point-to-point dial-up connection, a cell phone network, or another network and its networking hardware in various examples including routers, switches, and various types of transmitters, receivers, or computer-readable transmission media. While computer systems configured as described above may be used to support the operation of the facility, those skilled in the art will readily appreciate that the facility may be implemented using devices of various types and configurations, and having various components. Elements of the facility may be described in the general context of computer-executable instructions, such as program modules, executed by one or more computers or other devices. Generally, program modules include routines, programs, objects, components, data structures, and/or the like configured to perform particular tasks or implement particular abstract data types and may be encrypted. Moreover, the functionality of the program modules may be combined or distributed as desired in various examples. Moreover, display pages may be implemented in any of various ways, such as in C++ or as web pages in XML (Extensible Markup Language), HTML (HyperText Markup Language), JavaScript, AJAX (Asynchronous JavaScript and XML) techniques or any other scripts or methods of creating displayable data, such as the Wireless Access Protocol (“WAP”). Typically, the functionality of the program modules may be combined or distributed as desired in various embodiments, including cloud-based implementations.

The following discussion provides a brief, general description of a suitable computing environment in which the invention can be implemented. Although not required, aspects of the invention are described in the general context of computer-executable instructions, such as routines executed by a general-purpose data processing device, e.g., a server computer, wireless device or personal computer. Those skilled in the relevant art will appreciate that aspects of the invention can be practiced with other communications, data processing, or computer system configurations, including: Internet appliances, hand-held devices (including personal digital assistants (PDAs)), wearable computers, all manner of cellular or mobile phones (including Voice over IP (VoIP) phones), dumb terminals, media players, gaming devices, multi-processor systems, microprocessor-based or programmable consumer electronics, set-top boxes, network PCs, mini-computers, mainframe computers, and the like. Indeed, the terms “computer,” “server,” “host,” “host system,” and the like are generally used interchangeably herein, and refer to any of the above devices and systems, as well as any data processor.

Aspects of the invention can be embodied in a special purpose computer or data processor that is specifically programmed, configured, or constructed to perform one or more of the computer-executable instructions explained in detail herein. While aspects of the invention, such as certain functions, are described as being performed exclusively on a single device, the invention can also be practiced in distributed environments where functions or modules are shared among disparate processing devices, which are linked through a communications network, such as a Local Area Network (LAN), Wide Area Network (WAN), or the Internet. In a distributed computing environment, program modules may be located in both local and remote memory storage devices.

Aspects of the invention may be stored or distributed on tangible computer-readable media, including magnetically or optically readable computer discs, hard-wired or preprogrammed chips (e.g., EEPROM semiconductor chips), nanotechnology memory, biological memory, or other computer-readable storage media. Alternatively, computer implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Furthermore, the term computer-readable storage media does not encompass signals (e.g., propagating signals) or transitory media.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples; alternative implementations may employ differing values or ranges. Furthermore, although certain steps, functions, or functionalities may be described herein as being performed by or at a particular device, various steps, functions, functionalities, or portions thereof, may be performed at other devices. For example, display previews may be generated at a server or client device.

The teachings of the invention provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements.

Any patents and applications and other references noted above, including any that may be listed in accompanying filing papers, are incorporated herein by reference. Aspects of the invention can be modified, if necessary, to employ the systems, functions, and concepts of the various references described above to provide yet further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims. In some cases, various steps in the algorithms discussed herein may be added, altered, or removed without departing from the disclosed subject matter. Those skilled in the art will appreciate that features described above may be altered in a variety of ways. For example, the order of the logic may be rearranged, sublogic may be performed in parallel, illustrated logic may be omitted, other logic may be included, etc.

To reduce the number of claims, certain aspects of the invention are presented below in certain claim forms, but the applicant contemplates the various aspects of the invention in any number of claim forms. For example, while only one aspect of the invention is recited as a means-plus-function claim under 35 U.S.C. §112(f), other aspects may likewise be embodied as a means-plus-function claim, or in other forms, such as being embodied in a computer-readable medium. (Any claims intended to be treated under 35 U.S.C. §112(f) will begin with the words “means for,” but use of the term “for” in any other context is not intended to invoke treatment under 35 U.S.C. §112(f).) Accordingly, the applicant reserves the right to pursue additional claims after filing this application to pursue such additional claim forms, in either this application or in a continuing application.

1. A computer-implemented method, performed by a system having a memory and a processor, for incorporating content into user-generated media, the method comprising:
retrieving, by the system, at least one of location or social activity information;
sending, by the system, the retrieved information to a server;
receiving, by the system, an indication of at least one effect selected based at least in part on the retrieved information; and
receiving, by the system, from the server, a unified media object that includes at least one piece of user-generated media and at least one effect selected based at least in part on the retrieved information.

2. The computer-implemented method of claim 1, wherein the user-generated media includes a video recorded using a third-party application and wherein the system is a mobile phone or tablet.

3. The computer-implemented method of claim 1, wherein the retrieved information includes location information determined by a polygonal shape defined at least in part by a latitude x/y pair and a longitude x/y pair.

4. The computer-implemented method of claim 1, wherein the retrieved information includes location information determined by a central latitude and longitude and a radius around the central latitude and longitude.

5. A computer-readable device storing instructions that, if executed by a computing system having a processor, cause the computing system to perform a method for incorporating content into user-generated media, the method comprising:
receiving at least one of location or social activity information;
identifying, based at least in part on the received information, at least one effect or piece of advertising media;
sending an indication of the identified at least one effect or piece of advertising media;
receiving user-generated media; and
combining the user-generated media and the at least one effect or piece of advertising media identified based at least in part on the received information.

6. The computer-readable device of claim 5, wherein the received information includes location information determined by proximity to a locating beacon.

7. The computer-readable device of claim 5, wherein the received information includes at least one piece of advertising media personalized based on information about a user.

8. The computer-readable device of claim 7, wherein the information includes at least one piece of demographic information and a name so that at least one piece of advertising media of the received information is personalized to include the at least one piece of demographic information and the name.

9. The computer-readable device of claim 5, wherein the received indication of the at least one effect or piece of advertising media is selected by a user.

10. The computer-readable device of claim 5, wherein the received information includes at least one piece of advertising media personalized based on information about an ongoing event of interest to the user.

11. The computer-readable device of claim 10 wherein the ongoing event of interest to the user is a sporting event and wherein the at least one piece of advertising media is personalized based on a current score of the sporting event.

12-23. (canceled)

24. The computer-implemented method of claim 1, wherein the unified media object includes the at least one effect selected based at least in part on the retrieved information overlaid on the user-generated media.

25. The computer-implemented method of claim 1, wherein the at least one effect selected based at least in part on the retrieved information includes a preroll advertisement placed before display of the user-generated media.

26. The computer-implemented method of claim 1, wherein the at least one effect selected based at least in part on the retrieved information includes a postroll advertisement placed after display of the user-generated media.

27. The computing system of claim 1, wherein the at least one effect selected based at least in part on the retrieved information includes audio.

28. The computer-readable device of claim 5, the method further comprising:
receiving, from an advertiser, a first piece of advertising media, a location, a date, a start time, and an end time;
storing a mapping between the advertiser, the first piece of advertising media, the location, the date, the start time, and the end time; and
wherein the identifying, based at least in part on the received information, at least one effect or piece of advertising media, is based at least in part on location information, date information, start time information, and end time information.

29. A computing system comprising:
a memory;
a processor;
a receiving component configured to receive at least one of location or social activity information;
an identifying component configured to identify, based at least in part on the received information, at least one effect or piece of advertising media;
a sending component configured to send an indication of the identified at least one effect or piece of advertising media;
a receiving component configured to receive user-generated media; and
a combining component configured to combine the user-generated media and the at least one effect or piece of advertising media identified based at least in part on the received information
wherein at least one of the components comprises computer-executable instructions stored in the memory for execution by the computing system.

30. The computing system of claim 29, further comprising:
a storing component configured to store:
a mapping between at least one location and at least one effect or between at least one location and at least one advertisement; and
a mapping between an indication of at least one social activity and at least one effect or between an indication of at least one social activity and at least one advertisement.

31. The computing system of claim 29, further comprising:
a storing component configured to store a mapping between at least combination of date and time and at least one effect or between at least combination of date and time and at least one advertisement.

32. The computing system of claim 29, wherein the identified at least one effect or piece of advertising media includes an indication of at least one piece of advertising media that includes at least two forms of advertising content, wherein the at least two forms of advertising content include a frame and a logo.

33. The computing system of claim 29, further comprising:
a removal component configured to remove a selected piece of advertising media from the user-generated media in response to determining that a receiving user subscribes to a service to avoid ads.

34. The computing system of claim 29, further comprising:
a receiving component configured to receive configuration information for the at least one effect or piece of advertising media; and
a sending component configured to send settings for the received configuration information for the at least one effect or piece of advertising media
wherein the unified media object is further based at least in part on the settings for the received configuration information for the at least one effect or piece of advertising media.

35. The computing system of claim 29, further comprising:
a sending component configured to send, to a user, a URL link to the combined user-generated media and the at least one effect or piece of advertising media.
